(19) United States
(12) Patent Application Publication
(10) Pub. No.: US 2008/0134931 A1
(43) Pub. Date: Jun. 12, 2008

(54) Plasterboards Provided With Antimicrobial Effect

(76) Inventors: Peter Wachtler, Krefeld (DE); Martin Kugler, Leichlingen (DE)

Correspondence Address: LANXESS CORPORATION, 111 RIDC PARK WEST DRIVE, PITTSBURGH, PA, 15275-1112, US

(21) Appl. No.: 11/884,808

(22) PCT Filed: Feb. 11, 2006
(86) PCT No.: PCT/EP2006/001272

§ 371 Date: Aug. 21, 2007

(30) Foreign Application Priority Data
Feb. 23, 2005 (DE) 10 2005 008 184.3

(51) Int. Cl. B32B 29/00; C09D 5/14

(52) U.S. Cl. 106/18.33; 106/15.05; 106/18.32; 428/537.7

(57) ABSTRACT

The invention relates to antimicrobially treated plasterboards which are treated with OPP in the gypsum core and may contain further biocidal components, either in the gypsum core or in one or both paper outer layers, for enhancing the effect.

The present invention relates to the use of o-phenylphenol for the production of antimicrobially treated plasterboards.

Plasterboards constitute a versatile construction material and form the basis of modern and efficient dry construction. Plasterboards have the advantage that they are very easy to process and economical and are the ideal construction material for rapid implementation of architectural and structural modifications, particularly in interior finishing. The commercial importance of plasterboards is considerable.

In principle, plasterboards (sandwich-type plasterboards) consist of a gypsum core which is adhesively bonded on both sides with a paper or cardboard which imparts stability to the gypsum.

The gypsum core consists of gypsum, preferably plaster of Paris, and secondary constituents, such as, for example, starch-based thickeners. The plaster of Paris can be obtained by calcining both natural gypsum and industrial gypsums. Accordingly, the gypsum core consists mainly of inorganic substances (calcium sulphate) with a small proportion of organic constituents, but one which is important for the functionality. The paper surrounding the gypsum core can have a relatively large basis weight range and can be appropriately conditioned for achieving additional properties, such as fire resistance or improved water resistance.

A disadvantage of sandwich-type plasterboards is their sensitivity to moisture, since this firstly may adversely affect the mechanical properties and secondly also permits the growth of undesired micro organisms. Although sandwich-type plasterboards, as construction material for interior finishing, are designed per se for a dry environment, they may in fact come into contact with moisture for a shorter or longer time at various points during their life cycle. This may occur as early as during the storage of freshly produced boards still containing residual moisture from the production, or, for example, during drying in new buildings, as a result of water damage, as a result of installation in humid rooms or due to persistently high natural relative humidity, for example in tropical countries. Under the adverse conditions of use described above, the growth of micro-organisms (bacteria, moulds, yeasts) may occur as a result of temporary or longer-lasting moistening of the construction material, in particular the occurrence of moulds presenting the greatest problems in practice.

The susceptibility of sandwich-type plasterboards to the undesired growth of micro-organisms under humid conditions is explained by the presence of organic constituents in this construction material. First to be mentioned here is the presence of starch, which contributes to the retention of the paper layers applied to the surface. Although starch accounts for only a very small proportion based on the total weight of the plasterboard, this available nutrient, together with other possible organic additives and the papers or cardboards also present on the surfaces, is sufficient for permanently promoting the growth of micro-organisms and, as a consequence of this, reducing the quality of the construction material and of the premises constructed therewith in the long term. The undesired growth of micro-organisms, in particular of fungi, on the surface of the sandwich-type plasterboards has a number of disadvantages:

micro-organisms constitute an aesthetic impairment of the plasterboards

the mechanical integrity of the board is adversely affected by moisture retention and thereby provides the medium for further growth of micro-organisms

odour changes

the phenomenon of “sick building syndromes” described in detail in the literature is due inter alia to exposure to fungal spores. In particular, people with and in any case increased susceptibility to allergenic agents can thus be exposed to a greater health risk in interior rooms with damp walls based on sandwich-type plasterboards.

There has in the past been no lack of attempts to solve the described problem of the attack of plasterboards by micro-organisms through various measures, such as, for example, by the use of antimicrobial substances. In principle, such antimicrobial substances or fungicides can be incorporated into the gypsum core (cf. for example U.S. Pat. No. 3,918,981) or homogenized in the papers and cardboard present on the surfaces (cf. for example U.S. Pat. No. 0,031,898), and optionally combined treatment of both board constituents may also be suitable.

However, these processes known from the prior art ensure protection of the plasterboards from microbial attack only with the use of active substances in such high concentration ranges that use acceptable from economic points of view was not possible and these processes therefore do not become established on an industrial scale.

The object of the present invention was to provide antimicrobial active substances or active substance mixtures, processes and methods which make it possible to protect plasterboards effectively and in the long term from microbial attack and at the same time to ensure good toxicological and ecotoxicological compatibility.

Surprisingly, it has now been found that the object described can be achieved by the use of the active substance o-phenylphenol for the antimicrobial treatment of plasterboards.

The present invention therefore relates to the use of o-phenylphenol, the sodium or potassium salts thereof or mixtures thereof for protecting plasterboards from attack and/or destruction by micro-organisms.

In a preferred embodiment of the invention, the active substance o-phenylphenol, the sodium or potassium salts thereof or mixtures thereof is or are introduced into the core of the plasterboard.

The amounts of o-phenylphenol (OPP), the sodium or potassium salts thereof or mixtures thereof which are incorporated into the gypsum core may vary and depend on various factors, such as, for example, the thickness of the board to be treated in each case, the microbiological susceptibility of the board materials specifically to be protected, the climatic conditions or certain characteristics in the room under construction (wet rooms, cellars, etc.).

Usually, o-phenylphenol (OPP) or the sodium or potassium salts thereof or mixtures thereof is or are used according to the invention in an amount such that the gypsum core of the plasterboard contains said active substances in a concentration of 50 to 3000 ppm, preferably 100 to 2000 ppm, particularly preferably 250-1500 ppm, based on the dry weight of the gypsum core.

By the use according to the invention, the resistance of the finished plasterboard to a high level of mould infestation is improved to such an extent that no growth of fungal spores is observable on a board treated according to the invention, in contrast to an untreated board (cf. Example 1).

By introducing further biocidal active substances into the gypsum core and/or paper part of the plasterboard, the effect of o-phenylphenol (OPP) and the sodium or potassium salt thereof can be optimized. The following fungicidal components A) are preferred for this purpose:

carbendazim

iodopropargyl butylcarbamate

sodium pyrithione

propiconazole

tebuconazole

tetramethyl dithiocarbamate (thiuram)

thiabendazole

zinc bisdimethyldithiocarbamate (ziram)

zinc pyrithione

The mixtures to be used according to the invention are generally used in amounts such that the gypsum core of the finished plasterboard has a concentration of, preferably, 50-1000 ppm of OPP or the sodium or potassium salts thereof or mixtures thereof, and a 50-2000 ppm of at least one further biocidal active substance A).

The use, according to the invention, of a mixture of i) o-phenylphenol, the sodium or potassium salts thereof or mixtures thereof and ii) thiabendazole is particularly preferred. This mixture is distinguished by a synergistic enhancement of activity, i.e. the fungicidal potency of the synergistic mixtures is unexpectedly higher than the sum of the fungicidal potencies of the respective fungicides alone.

The synergistic mixture to be used according to the invention contains the active substances i) to ii) in the ratio 250:1 to 1:250, preferably 125:1 to 1:125, in particular 100:1 to 1:100.

In the case of the use according to the invention, the active substance o-phenylphenol, the sodium or potassium salts thereof or mixtures thereof and optionally further fungicidal active substances A) are mixed with the gypsum slurry during the process for the production of the plasterboards. It is possible to add the active substance o-phenylphenol (OPP) or the sodium or potassium salt thereof and the further active substances A) optionally to be added in various forms familiar to the person skilled in the art to the gypsum slurry. Thus, the active substance o-phenylphenol (OPP) or the sodium or potassium salts thereof can be added to the gypsum slurry, for example, in the solid state or dissolved or dispersed in water, alkalis or solvents.

The mixtures according to the invention which are to be used and which comprise o-phenylphenol, the sodium or potassium salts thereof or mixtures thereof with at least one further fungicidal active substance A) can, depending on the respective physical and/or chemical properties of the individual active substances or the specific requirements of the preservation problem to be solved, either be introduced separately in the form of metering of the individual active substances to the gypsum slurry, it being possible to adjust the concentration ratio individually according to the existing preservation problem, or the active substance mixture required for protecting the plasterboards can be added as a ready-formulated product to the gypsum slurry during the process for the production of the plasterboards.

The mixture to be used according to the invention or the active substance o-phenylphenol (OPP) or the sodium or potassium salt thereof can be converted beforehand into a customary formulation, such as, for example, into a solution, emulsion, suspension, a powder, a foam, into pastes, granules, aerosols and into very finely encapsulated form in polymeric substances.

These formulations can be prepared in a manner known per se, for example by mixing the mixture according to the invention or the individual active substances present therein with extenders, i.e. liquid solvents, liquefied gasses under pressure and/or solid carriers, optionally with use of surface-active agents, i.e. emulsifiers and/or dispersants and/or foam-producing agents. In the case of the use of water as an extender, for example, organic solvents may additionally be used as auxiliary solvents. Suitable liquid solvents are substantially: alcohols, such as butanol or glycol, and the ethers and esters thereof, ketones, such as acetone, methyl ethyl ketone, methyl isobutyl ketone or cyclohexanone, strongly polar solvents, such as dimethylformamide, N-methylpyrrolidone or dimethyl sulphoxide and water; liquefied gaseous extenders or carriers are understood as meaning those liquids which are gaseous at normal temperature and under atmospheric pressure, e.g. aerosol propellants, such as halohydrocarbons, and butane, propane, nitrogen and carbon dioxide; suitable solid carriers are: e.g. ground natural minerals, such as kaolin, clays, talc, chalk, quartz, attapulgite, montmorillonite or diatomaceous earth, and ground synthetic minerals, such as finely divided silica, alumina and silicates; suitable solid carriers for granules are: e.g. crushed and fractionated natural minerals, such as calcite, marble, pumice, sepiolite and dolomite, and synthetic granules of inorganic and organic powders and granules of organic material, such as sawdust, coconut shells, maize cobs and tobacco stalks; suitable emulsifiers and/or foam-producing agents are: e.g. non-ionic and anionic emulsifiers, such as polyoxyethylene fatty acid esters, polyoxyethylene fatty alcohol ethers, e.g. alkylarylpolyglycol ethers, alkanesulphonates, alkylsulphates, arylsulphonates and protein hydrolysis products; suitable dispersants are: e.g. ligninsulphite waste liquors and polyacrylates.

Tackifiers and thickeners, such as carboxymethylcellulose, methylcellulose, natural and synthetic, pulverulent, granular or latex-like polymers, such as gum arabic, polyvinyl alcohol, polyvinyl acetate and natural phospholipids, such as cephalins and lecithins, and synthetic phospholipids, can be used in the formulations. Other possible additives are mineral and vegetable oils.

The incorporation of the fungicidal components A) into the cardboard or paper layers surrounding the gypsum core can be effected by one of the methods known to the person skilled in the art, such as for example, by addition to the headbox of the paper machine, by incorporation via the size press, by addition to coating slips or by spraying on. The method of incorporation to be used in the individual case depends on the active substance sought, the respective preparation form (solid, dispersed, dissolved, emulsified) and the given general operating conditions. In a preferred embodiment of the invention, the production of the fungicidal cardboards or paper is effected during papermaking itself and not in the course of the final production of the plasterboards.

### USE EXAMPLES

### Example 1

For checking the effectiveness of a plasterboard treated with OPP in the gypsum core, the resistance was investigated in the laboratory after inoculation with a fungal mixture. For this purpose, sandwich-type plasterboard samples having the dimensions 14×5 cm are transferred to a 1 litre powder bottle and suspended by the bottle cap. At the start of the experiment, the test specimens thus prepared are immersed once in a mixture of the following moulds to simulate a strong fungal attack:

Penicillium glaucum

Chaetomium globosum

Aspergillus niger

Aureobasidium pullulans

The mould species are material pests well known to the person skilled in the art and are therefore suitable for a qualifying conclusion about the degree of antimicrobial protection of a product treated with an OPP or the sodium or potassium salt thereof and optionally further active components. The sample boards are stored at room temperature over a period of up to 8 weeks, a water vapour-saturated atmosphere being continuously ensured by maintaining the initial amount of water at the bottom of the vessel (direct contact between plasterboard and water is not permitted). The assessment of the test specimens is effected at certain times and is carried out according to the following rating scheme:

0=no growth on the surface

1=slight growth (<10% of the surface infested)

2=moderate growth (<50% of the surface infested)

3=strong growth on the surface

### Results

Microbiological resistance of a plasterboard contaminated once in a humid environment

TABLE 1

| | |
|---|---|
| Amount of OPP in the gypsum | Rating |

| core of the plasterboard | | 1 | 3 | 4 | 8 Weeks |
|---|---|---|---|---|---|
| 0 | ppm | 0/0 | 3/3 | 3/3 | 3/3 |
| 300 | ppm | 0/0 | 0/0 | 0/0 | 0/0 |
| 500 | ppm | 0/0 | 0/0 | 0/0 | 0/0 |
| 750 | ppm | 0/0 | 0/0 | 0/0 | 0/0 |

In this test, good effectiveness of OPP was found under the test conditions described from a concentration of use of only 300 ppm of o-phenylphenol (OPP), based on the weight of the gypsum core. Thus, a plasterboard treated with this amount of o-phenylphenol in the gypsum core has a high resistance to attack by material-damaging micro-organisms, in particular by moulds, under the conditions of the test described here.

### Example 2

For improving the overall performance of an antimicrobial treatment, the use of active substance mixtures is customary for compensating, for example, for gaps in the activity of one component or for optimizing the costs of preservation. A mixture according to the invention comprising OPP and the second fungicidal component thiabendazole was investigated, a surprisingly high, synergistic effect being found against certain micro-organisms, in particular those relevant in practice, such as, for example, Aspergillus flavus (Table 2), i.e. the activity of the mixture is better than that which would have been derivable from the activity of the individual components.

The synergism found for the mixture according to the invention can be determined via the following mathematical formula (cf. F. C. Kull, P. C. Elisman, H. D. Sylwestrowicz and P. K. Mayer, Appl. Microbiol. 9, 538 (1961):

$$synergistic index ( S I ) = \frac{{Q}_{a}}{{Q}_{A}} + \frac{{Q}_{b}}{{Q}_{B}}$$

where

Qₐ=amount of component A in the active substance mixture which achieves the desired effect, i.e. no microbial growth,

Q_{A}=amount of component A which, when used alone, suppresses the growth of the micro-organisms,

Q_{b}=amount of component B in the active substance mixture which suppresses the growth of the micro-organisms,

Q_{B}=amount of component B which, when used alone, suppresses the growth of the micro-organisms.

Synergism of o-phenylphenol (OPP)/thiabendazole (TBZ)

Using the test micro-organism, Aspergillus flavus, the minimum inhibitory concentration of the active substance combinations listed in Table 2 were investigated.

TABLE 2
Aspergillus flavus

| | | SI |
|---|---|---|
| Amount of pure active substances which suppress growth (in ppm) | | |
| A = OPP | (Q_{A}) = 100 | |
| B = TBZ | (Q_{B}) = 500 | |
| Proportions in the active substance | | |
| mixtures which suppress growth (in ppm) | | |
| OPP/TBZ (=9:1)* | (Qₐ/Q_{A}) = 0.9/(Q_{b}/Q_{B}) = 0.02 | 0.92 |
| OPP/TBZ (=8:2)* | (Qₐ/Q_{A}) = 0.4/(Q_{b}/Q_{B}) = 0.02 | 0.42 |
| OPP/TBZ (=7:3)* | (Qₐ/Q_{A}) = 0.35/(Q_{b}/Q_{B}) = 0.03 | 0.38 |
| OPP/TBZ (=6:4)* | (Qₐ/Q_{A}) = 0.3/(Q_{b}/Q_{B}) = 0.04 | 0.34 |
| OPP/TBZ (=5:5)* | (Qₐ/Q_{A}) = 0.25/(Q_{b}/Q_{B}) = 0.05 | 0.30 |
| OPP/TBZ (=4:6)* | (Qₐ/Q_{A}) = 0.2/(Q_{b/}Q_{B}) = 0.06 | 0.26 |
| OPP/TBZ (=3:7)* | (Qₐ/Q_{A}) = 0.15/(Q_{b}/Q_{B}) = 0.07 | 0.22 |
| OPP/TBZ (=2:8)* | (Qₐ/Q_{A}) = 0.1/(Q_{b}/Q_{B}) = 0.08 | 0.18 |
| OPP/TBZ (=1:9) | (Qₐ/Q_{A}) = 0.05/(Q_{b}/Q_{B}) = 0.09 | 0.14 |

(*= weight ratios of the active substances in the mixture)

In certain concentration ratios, the combinations according to the invention have a pronounced synergistic effect. The incorporation of a mixture of OPP and TBZ into the gypsum core accordingly leads to an improvement in the effect achievable with OPP alone. Alternatively, a certain amount of OPP can also be incorporated in the gypsum core and a fungicidal treatment with TBZ can be effected in one paper outer layer or in both paper outer layers for enhancing the effect.

1. A process for protecting plasterboard comprising a) a gypsum core and b) at least one paper or cardboard outer layer surrounding said gypsum core, from attack and/or destruction by micro-organisms, comprising the steps of:
contacting said plasterboard and/or its components with o-phenylphenol and/or the sodium or potassium salts thereof and/or mixtures thereof.

2. The process according to claim 1, wherein the o-phenylphenol and/or the sodium or potassium salts thereof and/or mixtures thereof are incorporated into the gypsum core.

3. The process according to claim 1, wherein the o-phenylphenol and/or the sodium or potassium salts thereof and/or mixtures thereof are incorporated into the gypsum core in a concentration of 50 to 3000 ppm, based on the dry weight of the gypsum core.

4. The process according to claim 1, further comprising:
incorporating at least one further biocidal active substance into the a) gypsum core and/or the b) at least one paper or cardboard outer layer.

5. The process according to claim 4, wherein said at least one further active substance is selected from the group consisting of carbendazim, iodopropargyl butylcarbamate, sodium pyrithione, propiconazole, tebuconazole, tetramethyl dithiocarbamate (thiuram), thiabendazole, zinc bisdimethyldithiocarbamate (ziram) and zinc pyrithione.

6. The process according to claim 1, wherein the o-phenylphenol and/or the sodium or potassium salts thereof and/or mixtures thereof are incorporated in a concentration of 501-1000 ppm into the gypsum core and further comprising;
incorporating at least one further biocidal active substance selected from the group consisting of carbendazim, isopropargyl butylcarbamate, sodium pyrithione, propiconazole, tebuconazole, tetramethyl dithiocarbamate (thiuram), thiabendazole, zinc bisdimethylthiocarbamate (ziram) and zinc pyrithione in a concentration of 50-2000 ppm into the gypsum core and/or into the paper or cardboard outer layer.

7. The process according to claim 1, characterized in that o-phenylphenol and/or the sodium or potassium salts thereof and/or mixtures thereof are incorporated into the gypsum core and further comprising:
incorporating thiabendazole into the gypsum core and/or the paper or cardboard outer layer.

8. An antimicrobially treated plasterboard comprising:
a) a gypsum core; and
b) at least one paper or cardboard outer layer surrounding said gypsum core,
wherein said gypsum core comprises o-phenylphenol and/or the sodium or potassium salts thereof and/or mixtures thereof.

9. The antimicrobially treated plasterboard according to claim 8, wherein said gypsum core and/or said at least one paper or cardboard outer layer further comprise one or more biocidal active substances.

10. The antimicrobially treated plasterboard according to claim 9, wherein said one or more biocidal active substances is selected from the group consisting of carbendazim, iodopropargyl butylcarbamate, sodium pyrithione, propiconazole, tebuconazole, tetramethyl dithiocarbamate (thiuram), thiabendazole, zinc bisdimethyldithiocarbamate (ziram) and zinc pyrithione.
